(19) United States
(12) Patent Application Publication
(10) Pub. No.: US 2013/0265785 A1
(43) Pub. Date: Oct. 10, 2013

(54) LAMP SEAT ASSEMBLY

(71) Applicants: MIN-JET LUI, Chu-Nan (TW); SUNG-HSIANG YANG, Chu-Nan (TW); WEI-CHUN YEH, Chu-Nan (TW)

(72) Inventors: MIN-JET LUI, Chu-Nan (TW); SUNG-HSIANG YANG, Chu-Nan (TW); WEI-CHUN YEH, Chu-Nan (TW)

(73) Assignee: FOXSEMICON INTEGRATED TECHNOLOGY, INC., Chu-Nan (TW)

(21) Appl. No.: 13/569,127

(22) Filed: Aug. 7, 2012

(30) Foreign Application Priority Data
Apr. 5, 2012 (TW) 101112091

(51) Int. Cl. F21V 21/088

(52) U.S. Cl. 362/396

(57) ABSTRACT

An exemplary lamp seat assembly includes a supporting member and a chassis. The supporting member includes receiving portion for receiving a light source therein and a plurality of clips. The chassis includes a holder for electrically connecting the light source and a power source and a main body mounted on the holder. The holder is a screw type bulb base. The main body includes a hollow cover, a plurality of baffling portions and a plurality of supporting portions formed on an inner surface of the cover. The supporting member abuts against the supporting portions and the clips clasp the baffling portions.

### BACKGROUND

1. Technical Field

The present disclosure relates to lamp seat assemblies, and more particularly to a lamp seat assembly easily to be disassembled or assembled.

2. Description of Related Art

The conventional lamp includes a seat assembly and a lamp body electronically mounted on the seat assembly. The seat assembly includes a chassis and a supporting member. The lamp body is supported by the supporting member. A plurality of screw holes is defined in the chassis. A plurality of through holes is defied in the supporting member and respectively aligned with the screw holes of the chassis. Screws one by one extend through the through holes of the supporting member and engage in the screw holes of the chassis to fix the supporting member to the chassis. It is time-consuming to assemble or disassemble the seat assembly.

It is thus desirable to provide a lamp seat assembly which can overcome the described limitations.

### BRIEF DESCRIPTION OF THE DRAWINGS

FIG. 1 is an assembled view of a lamp seat assembly according to an embodiment of the present disclosure.

FIG. 2 is an exploded view of the lamp seat assembly of FIG. 1.

FIG. 3 is an inverted view of FIG. 2.

FIG. 4 is an inverted, cross-sectional view of the lamp seat assembly of FIG. 1.

### DETAILED DESCRIPTION

Embodiments of lamp seat assembly will now be described in detail below and with reference to the drawings.

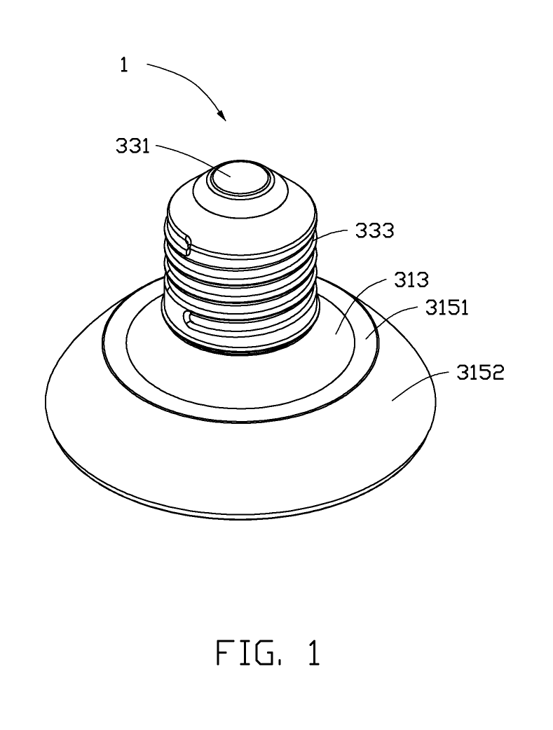

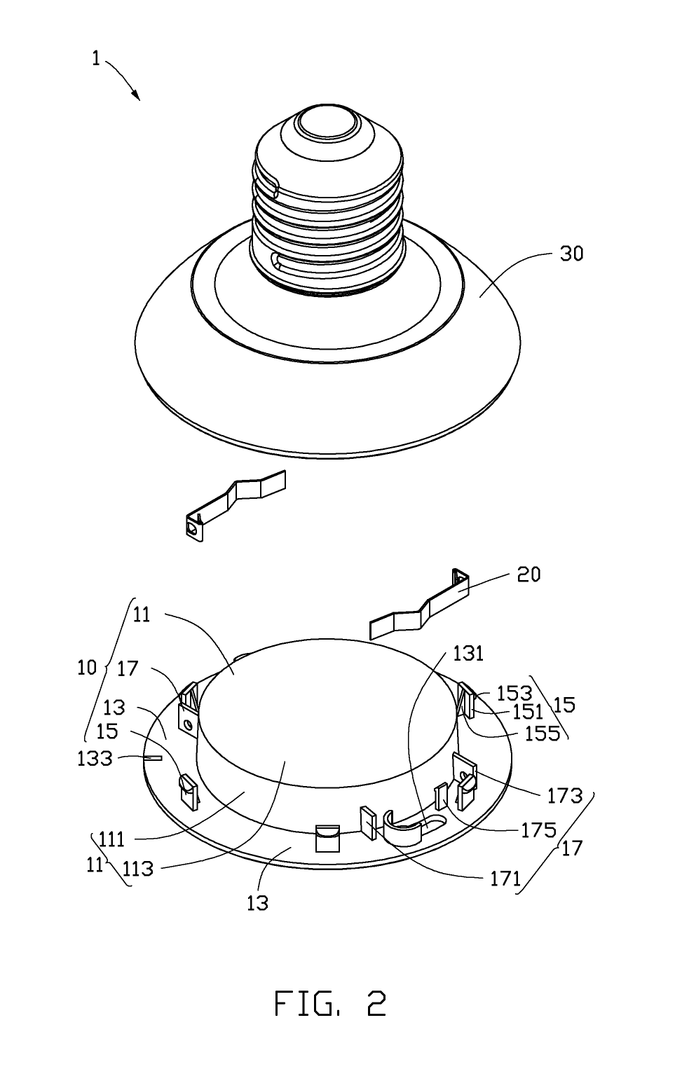

Referring to FIGS. 1-2, a lamp seat assembly 1 according to an embodiment of the present disclosure includes a chassis 30 and a supporting member 10 mounted on the chassis 30.

In the description that follows, the stated orientations of all of the elements of the lamp seat assembly 1 are with reference to the orientations of all of the elements as shown in FIG. 1.

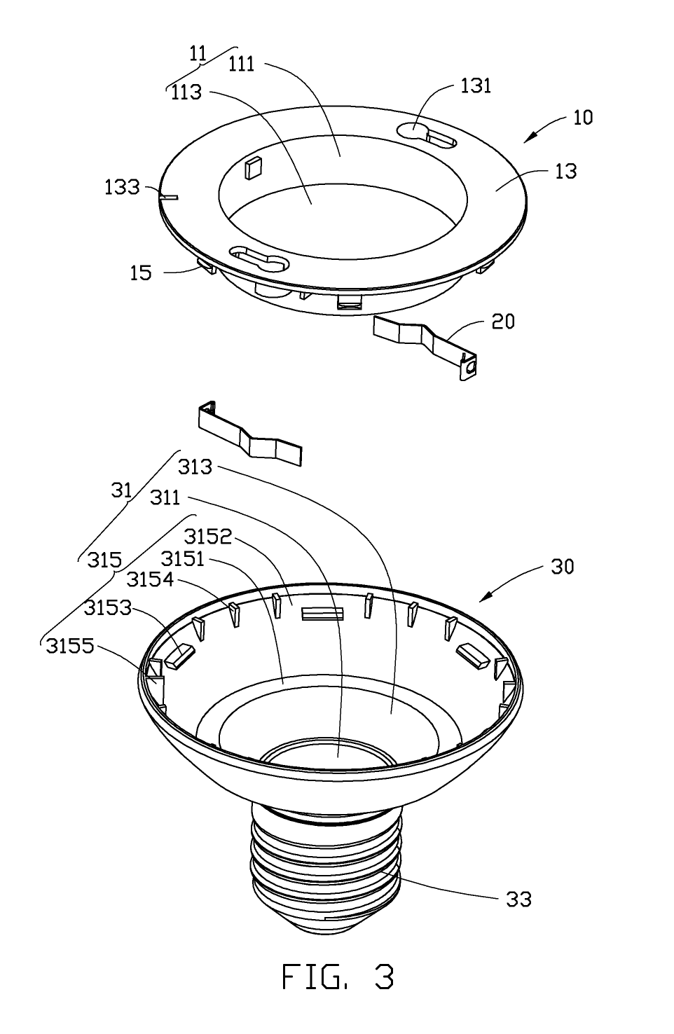

The supporting member 10 includes a receiving portion 11, a flange 13 extending outwardly from a periphery of a bottom end of the receiving portion 11, a plurality of clips 15 formed on the flange 13 and two securing portions 17 connecting the receiving portion 11 and the flange 13. The clips 15 clasp the chassis 30. The receiving portion 11 is a hollow, cylindrical tube, and includes a cylindrical sidewall 111 and a disk-like top plate 113 closed a top end of the sidewall 111. The receiving portion 11 is used to define a space (not labeled and best seen in FIG. 3) below the top plate 113 and surrounded by the sidewall 111 which can receive a light source (not shown), such as LEDs, therein. The flange 13 is annular and extends horizontally from a periphery of the bottom end of the receiving portion 11. A thickness of the flange 13 is less than a height of the receiving portion 11. A bottom surface of the flange 13 and a bottom end of the sidewall 111 are coplanar. Two through holes 131 are defined in the flange 13. The through holes 131 are located at opposite sides of the receiving portion 11. A slit 133 is defined at an outer end of the flange 13 and extends along a radial direction of the flange 13.

The clips 15 are evenly formed on a top surface of the flange 13 with a predetermined distance defined between each two adjacent clips 15. Each clip 15 includes a rectangular arm 151, a ridge 153 and a rib 155. The arm 151 extends upwardly from the top surface of the flange 13 and is space from an outer periphery of the sidewall 111 of the receiving portion 11. The ridge 153 is formed on a top end of an outer surface of the arm 151 and a bottom end thereof is located above of the top surface of the flange 13. The rib 155 is a triangular, an outer side thereof is connected to an inner surface of the arm 151 and a bottom end thereof connects the top surface of the flange 13 to enhance a strength of the arm 151.

The securing portions 17 fix two electronic conductive sheets 20 to the flange 13 and are located around the through holes 131 of the flange 13, respectively. Each electronic sheet 20 is a bended metal sheet and used for electronically connecting with the light source. Each securing portion 17 includes a first restricting plate 171, a second restricting plate 173 spaced from and facing the first restricting plate 171, and a clasp 175 located between the first restricting plate 171 and the second restricting plate 173. Each of the first restricting plate 171 and the second restricting plate 173 is a rectangular plate. Bottom ends of the first restricting plate 171 and the second restricting plate 173 connect the top surface of the flange 13. Inner sides of the first restricting plate 171 and the second restricting plate 173 connect the outer periphery of the sidewall 111 of the receiving portion 11. The clasp 175 extends upwardly from the top surface of the flange 13 and is spaced from the outer periphery of the sidewall 111 of the receiving portion 11. The through holes 131 each are located between the first restricting plate 171 and the clasp 175 of a corresponding securing portion 17.

When the electronic conductive sheet 20 is fixed on the flange 13, opposite ends thereof abut against inner surfaces of the first restricting plate 171 and the second restricting plate 173, a top side thereof is clasped by the clasp 175, and a bottom side thereof abuts against the top surface of the flange 13. A part of the bottom side of the electronic sheet 20 is exposed from the through hole 131 to electronically connect the light source.

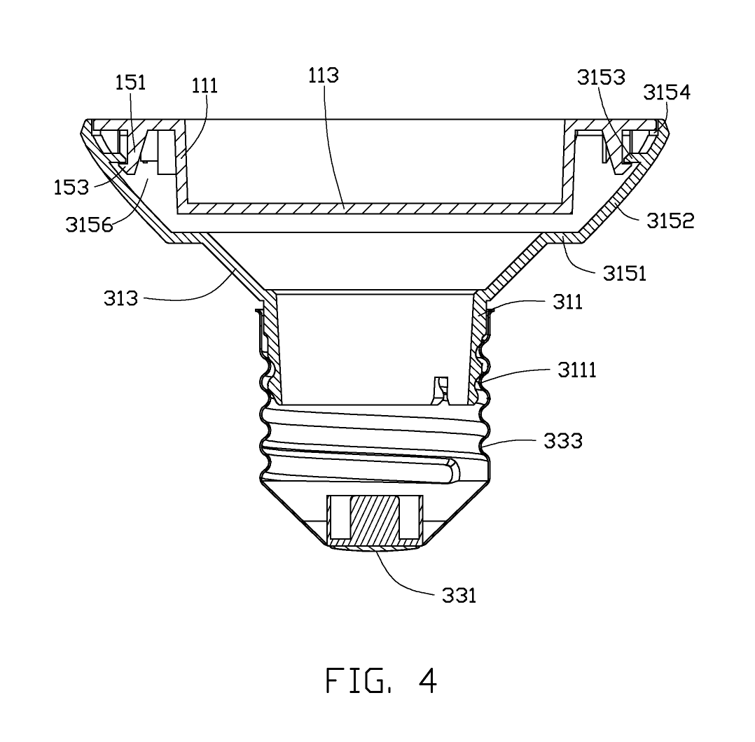

Referring to FIGS. 3-4, the chassis 30 includes a main body 31 and a holder 33 engaging with the main body 31.

The holder 33 is configured for screwing into a socket (not shown) for electrically connecting a power source. The holder 31 is a hollow tube with a top end thereof being closed. Preferably, the holder 33 is a standard E26/E27 bulb base. A metallic patch 331 is formed on an outside of the top end of the holder 33. The metallic patch 331 functions as a positive electrode and a plurality of threaded 333 formed on the holder 10 functions as a negative electrode to electrically connect the power source to drive the light source to lighten. The holder 33 is a standard element, so the lamp seat assembly 1 can be directly connected to a standard socket matching with the standard holder 33 to electrically connect with the power source. Thus, an LED bulb with the lamp seat assembly 1 of the present disclosure can be readily used in the present lighting environment.

The main body 31 includes a connecting portion 311, an extending portion 313, and an engaging portion 315. The connecting portion 311 is cylindrical and outer periphery thereof formed a plurality of threads 3111 engaging with the threads 333 of the holder 33. The extending portion 313 is a hollow tube and extends downwardly and outwardly from a bottom end of the connecting portion 311. A bore diameter of the extending portion 313 increases from a top end thereof connecting the connecting portion 311 to a bottom end thereof away from the connecting portion 311.

The engaging portion 315 includes a stretching arm 3151, a cover 3152 extending downwardly from the stretching arm 3151, a plurality of baffling portions 3153, a plurality of supporting portions 3154, and a stopping portion 3155. The baffling portions 3153, the supporting portions 3154, and the stopping portion 3155 are formed on an inner surface of the cover 3152. The stretching arm 3151 is an annular plate and horizontally extends from a bottom end of the extending portion 313. The cover 3152 is a hollow tube and extends downwardly and outwardly from an outer edge of the stretching arm 3151. A bore diameter of the cover 3152 increases from a top end thereof connecting the stretching arm 3151 to a bottom end thereof away from the stretching arm 3151. The bore diameter of the bottom end of the cover 3152 is equal to the diameter of the flange 13. Thus, the flange 13 can received in the bottom end of the cover 3152. The inner surface of the cover 3152 surrounds a receiving chamber 3156 to receive the supporting member 10 therein. A distance between the top end and the bottom end of the cover 3152 is larger than the height of the supporting member 10.

The baffling portions 3153 are evenly arranged on the bottom end of the inner surface of the cover 3152 and spaced from each other. The clips 15 of the supporting member 10 clasp the baffling portions 3153. In this embodiment, a number of the baffling portions 3153 is six and each baffling portion 3153 is a rectangular block protruded from the inner surface of the cover 3152. A thickness of the baffling portion 3153 is less than a height of the arm 151 of the clip 15.

The supporting portions 3154 are evenly arranged on the bottom end of the inner surface of the cover 3152 to abut against an outer periphery of the flange 13. The supporting portions 3154 are spaced from each other and divided into a plurality of groups by the baffling portions 3153. Each group includes three supporting portions 3154 and is located between two adjacent baffling portions 3153. In this embodiment, each supporting portion 3154 is a triangular plate, a bottom end thereof is located below of the baffling portion 3153 and adjacent to a bottom edge of the cover 3152, a slantwise outer side thereof connects the inner surface of the cover 3152, and a vertical inner side thereof interconnects an inner edge of the bottom end and a top edge of the slantwise outer side of each supporting portion 3154. The bottom ends of the supporting portions 3154 are coplanar and located at a top of the bottom edge of the cover 3152 to support the flange 13 of the supporting member 10.

One of the supporting portions 3154 is enlarged to form the stopping portion 3155. The stopping portion 3155 has a vertical inner side away from the inner surface of the cover 3152. A distance between the inner surface of the cover 3152 and the vertical inner side of the stopping portion 3155 is larger than a distance between the inner surface of the cover 3152 and the vertical inner side of each of the supporting portions 3154.

In assembly, the supporting member 10 is aligned with the receiving chamber 3156 of the chassis 30, and the stopping portion 3155 of the chassis 30 is aligned with the slit 133 of the supporting member 10. The supporting member 10 is pressed towards the chassis 30 until the receiving portion 11 is received in the receiving chamber 3156 of chassis 30, the clips 15 slide along inner edges of the baffling portions 3153 and clasp the baffling portions 3153, the stopping portions 3155 is inserted in the slit 133, and the flange 13 abuts the bottom ends of the supporting portions 3154. In this state, the outer surfaces of the arms 151 abut inner ends of the baffling portions 3153 away from the inner surface of the cover 3152, and the ridges 153 abut top surfaces of the baffling portions 3153. The vertical inner side of the stopping portion 3155 abuts against the flange 13 defining an inner edge of the slit 133. A bottom surface of the flange 13 and the bottom edge of the cover 3152 are coplanar. In this state, the lamp seat assembly 1 is assembled together.

In disassembly, the supporting member 10 is drawn from the chassis 30 to make the clips 15 sliding along the inner edges of the baffling portions 3153 until the clips 15 are disassembled from the baffling portions 3153. In this state, the supporting member 10 and the chassis 30 are disassembled.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lamp seat assembly comprising:
a supporting member configured for supporting a light source therein, comprising a plurality of clips extending from the supporting member; and
a chassis comprising a holder configured for electrically connecting the light source and a power source, and a main body mounted on the holder, the main body comprising a hollow cover, a plurality of baffling portions and a plurality of supporting portions formed on an inner surface of the cover, and the supporting member abutting against the supporting portions and the clips clasping the baffling portions.

2. The lamp seat assembly of claim 1, wherein the baffling portions are protruded from the inner surface of the cover and the clips abut top surfaces of the baffling portions facing the holder.

3. The lamp seat assembly of claim 2, wherein the supporting member comprises a receiving portion and a flange extending from the receiving portion, the clips are formed on the flange, each clip comprises an arm extending from the flange and a ridge formed on a top end of an outer surface of the arm, the outer surface of the arm abuts an inner end of a corresponding baffling portion and the ridge abuts a top surface of the corresponding baffling portion.

4. The lamp seat assembly of claim 3, wherein a rib is formed on an inner surface of each arm and a bottom end thereof connects the flange to enhance a strength of the each clip.

5. The lamp seat assembly of claim 3, wherein the receiving portion of the supporting member is received in a receiving chamber surrounded by the inner surface of the cover and the flange abuts against the supporting portions.

6. The lamp seat assembly of claim 5, wherein the supporting portions are protruded from the inner surface of the cover and bottom ends thereof are coplanar to support the flange thereon.

7. The lamp seat assembly of claim 5, wherein the baffling portions are formed near a bottom end of the cover away from the holder, and a bore diameter of the cover increases from a top end near the holder to the bottom end.

8. The lamp seat assembly of claim 3, wherein a slit is defined at an outer end of the flange along a radial direction of the flange, and a stopping portion is protruded from the inner surface of the cover and is inserted in the slit and abuts against the flange defining an inner edge of the slit.

9. The lamp seat assembly of claim 3, wherein two spaced restricting plates are mounted on the flange, a clasp is formed on the flange and located between the two restricting plates, an electronic conductive sheet is mounted on the flange, opposite sides of the electronic conductive sheet respectively abut the clasp and the flange, and opposite ends of the electronic conductive sheet respectively abut the first and second restricting plates.

10. The lamp seat assembly of claim 9, wherein a through hole is defined in the flange to expose a part of the electronic conductive sheet.

11. The lamp seat assembly of claim 1, wherein the main body further comprises a connecting portion engaging with the holder, an extending portion extending downwardly from the connecting portion, and a stretching arm horizontally extending from the extending portion and connecting a top end of the cover.

12. A lamp seat assembly comprising:
a supporting member comprising a receiving portion configured for receiving a light source therein, a flange extending outwardly from a bottom end of the receiving portion, and a plurality of clips formed on a top surface of the flange; and
a chassis comprising a holder configured for electrically connecting the light source and a power source, and a main body mounted on the holder and comprising a hollow cover, a plurality of baffling portions and a plurality of supporting portions formed on an inner surface of the cover, the receiving portion received in the cover, the top surface of the flange abutting the supporting portions, and the clips clasping the baffling portions.

13. The lamp seat assembly of claim 12, wherein each clip comprises an arm extending from the top surface of the flange and a ridge formed on a top end of an outer surface of the arm, the outer surface of the arm abuts an inner end of a corresponding baffling portion and the ridge abuts a top surface of the corresponding baffling portion facing the holder.

14. The lamp seat assembly of claim 13, wherein a rib is formed on an inner surface of each arm and a bottom end thereof connects the flange to enhance a strength of the each clip.

15. The lamp seat assembly of claim 12, wherein the supporting portions are protruded from the inner surface of the cover and bottom ends thereof are coplanar to support the flange thereon.

16. The lamp seat assembly of claim 15, wherein a bottom surface of the flange and a bottom end of the cover are coplanar.

17. The lamp seat assembly of claim 12, wherein a slit is defined at an outer end of the flange along a radial direction of the flange, and a stopping portion is protruded from the inner surface of the cover and is inserted in the slit and abuts against the flange defining an inner edge of the slit.
